(19) United States
(12) Patent Application Publication
(10) Pub. No.: US 2024/0341285 A1
(43) Pub. Date: Oct. 17, 2024

(54) AUTOMATED FILLING BIRD FEEDER

(71) Applicant: Jeffrey Scott Faubert, Oscoda, MI (US)

(72) Inventor: Jeffrey Scott Faubert, Oscoda, MI (US)

(21) Appl. No.: 18/631,946

(22) Filed: Apr. 10, 2024

Related U.S. Application Data
(60) Provisional application No. 63/577,260, filed on Apr. 11, 2023.

(51) Int. Cl. A01K 39/012

(52) U.S. Cl. CPC A01K 39/012

(57) ABSTRACT

An automatic bird feeder comprised of a lower unit, a hollow post, and a hopper unit wherein the lower unit is on the bottom and the hopper unit is on the top with the hollow post connecting the two. The lower unit comprises a base and a concave inset basin, with the concave inset basin being on top of the base. The base includes a blower with its nozzle fixed in an upward position. The concave inset basin includes a means to be filled with birdseed. The automatic bird feeder can be used either by manually plugging in the blower to a power supply or by powering it on with a remote. When on, the blower transports the birdseed from the lower unit through the hollow post and into the hopper unit. Apertures in the hopper unit allow access to the feed.

### BACKGROUND OF THE INVENTION

A hopper bird feeder is a type of feeder designed to hold and dispense birdseed. The seeds are dispensed onto a tray on the bottom of the bird feeder, from which birds may access the seed through openings. Conventional bird feeders are known to have tedious maintenance requirements and have a labor-intensive reputation of upkeep. The considerable time and effort required for conventional tasks such as refilling, cleaning, and maintenance can prove inconvenient and dissuade people from bird feeding activities. This reluctance can have a negative effect on local ecosystems, potentially impacting bird populations and disturbing local ecological balances.

While hopper feeders are effective for attracting birds, their design can present significant challenges for users when it comes to refilling them. Accessing the feeder's interior to refill it often requires removing a lid or roof, which can be inconvenient and time-consuming, especially if the feeder is mounted at a height or in a difficult location. Many contemporary bird feeders contain feed filling ports at the top of their hopper units, which could stand upwards of six feet tall. Furthermore, the need to refill hopper feeders frequently, especially in areas with high bird activity, adds to the labor-intensive nature of maintaining these feeders. In addition, these feeders are susceptible to toppling over in outdoor settings, especially during periods of high winds or inclement weather conditions. The instability of these feeders may pose potential hazards to the feeder, the birds, and the surrounding environment.

These challenges can discourage consistent bird-feeding practices and limit the accessibility of enjoying birdwatching activities for individuals who may face difficulties in maintaining traditional feeders. Wild bird populations become accustomed to reliable feed sources, and for some populations, feeders are essential to help the populations survive the harsh winter months. Birds may be harmed by a lack of bird feeding activity and by less frequent feeding and refilling. Due to their cumbersome maintenance requirements, traditional bird feeders allow for bird feed to become stagnant and subject to inclement climates, which can result in the growth of mold and other unwanted microbes. The consumption of these microbes can harm and kill off local bird populations. In conjunction with the pathogens associated with stagnant bird feed, traditional bird feeders dispense high volumes of feed in a “spill-out” method. Combining these practices with high volumes of stagnant feed, large swaths of bird populations can become ill from the stagnant feed. Further, due to the tedious demands associated with traditional bird feeders, users often resort to having fewer bird feeders in fewer locations. This decreases the number of feeding locations for birds, which increases the amount of birds per feeder. By having a larger volume of birds per feeder, there is an increased risk of communicable diseases spreading between birds.

In attempts to address the limitations of manual bird feeders, various remedies have been proposed, but many have been unsuccessful in fully mitigating the issues. For instance, some designs have incorporated larger seed compartments to reduce the frequency of refilling, but this often results in bulkier and more cumbersome feeders. Others have introduced heavier bases or anchoring mechanisms to enhance stability, yet these solutions can still prove inadequate in extreme weather conditions.

The envisioned feeder seeks to bridge the gap between conventional feeder designs and the evolving needs of users, particularly individuals with disabilities or elderly users who may encounter challenges in venturing outdoors to refill their bird feeders. By offering a solution that prioritizes ease of use, stability, and accessibility, this invention aims to revolutionize the bird-feeding experience, fostering greater enjoyment and engagement with nature, while minimizing the burdensome aspects traditionally associated with feeder maintenance.

### SUMMARY OF THE INVENTION

The present disclosure relates to an automatic bird feeder, more particularly a free-standing bird feeder comprising an upper hopper unit, connected to a lower unit through a singular hollow post. In one embodiment the hopper unit is further comprised of a right circular cone, a feeding area, multiple feed apertures, a supply outlet, and a perch. In one embodiment the lower unit further comprises a base and a concave inset basin, wherein the base has multiple handles, multiple inlets, a cord hole, and a blower, and wherein the concave inset basin is attached to the distal end of the base. The concave inset basin further comprising a supply port, a cover for the supply port, a bowl, and a meshed junction.

One exemplary embodiment of the automatic bird feeder is configured to allow users to insert bird seed into the concave inset basin through a supply port at the lower end of the bird feeder unit. After activating the blower unit, either manually or by remote control, the air from the blower unit carries the bird seed vertically through the hollow post into the hopper unit, where it hits the airflow dampener at the axle end of the right circular cone wherein the seed then falls to the base of the feeding area, with the supply outlet keeping the seed from congregating in the center of the hopper unit. Once the hopper unit of one embodiment is filled with seed the blower may be turned off, either manually or by remote control, with the process repeating until the basin requires refilling.

In one exemplary embodiment when seed fills the feeding area, the wild bird seed will likely spill out of the hopper unit through the multiple feed apertures and onto the surrounding ground floor. One exemplary embodiment of the invention also has an enhanced feed storage capacity, capable of accommodating a maximum weight of 50 lbs. In some exemplary embodiments, the automatic bird feeder is constructed of a plastic material. In some exemplary embodiments, the automatic bird feeder is constructed of wooden material. In some exemplary embodiments, the automatic bird feeder is constructed of a variety of metal alloys. In one exemplary embodiment the blower connects to an AC/DC power system. In another exemplary embodiment the blower connects to a variety of environmental power systems. In some exemplary embodiments, the blower has a manual electrical power switch, and in another exemplary embodiment the blower is connected to a remote control.

One aspect of the present disclosure is directed to an automatic bird feeder apparatus comprising:
a lower unit, a hollow post, a hopper unit, a proximal end of the feeder, and a distal end of the feeder, wherein the lower unit on the proximal end of the feeder and the hopper unit on the distal end of the feeder are connected by the hollow post; wherein the lower unit further comprises a base and a concave inset basin; and wherein the base further comprises a base proximal end and a base distal end; and wherein the base further comprises a blower, wherein the blower is fixed to the base proximal end; and wherein the concave inset basin further comprises a concave inset basin proximal end and a concave inset basin distal end; and wherein the concave inset basin proximal end is fixed to the base distal end; and wherein the concave inset basin further comprises a basin and a disk, wherein the disk is fixed on top of the basin; and wherein the hopper unit is further comprised of a perch, a supply outlet, a feeding area, and a right circular cone; and wherein the feeding area contains a plurality of feed apertures on external portions of the feed area; and wherein the supply outlet is fixed within the feeding area and connects the upper end of the hollow post to the upper portion of the perch; and wherein the right circular cone, being hollow contains a curved airflow dampener fixed on an inner axle end.

In one embodiment, the blower further comprises a nozzle end and a motor end, wherein the motor end is fixed to the base proximal end and the nozzle end is pointed upward vertically; and a remote attachment, wherein the remote attachment is fixed to the motor end. In another embodiment, the blower can be operable manually or by remote control. In one embodiment, the base further comprises a minimum of two attached handles each positioned above one or more air inlets on opposing sides of external walls of the base. In another embodiment, the base further comprises a cord hole, an electrical cord, and wherein the cord hole is adjacent to the base proximal end and the electrical cord is connected to the blower and exits through the cord hole to be attached to a power supply.

In one embodiment of the bird feeder, the concave inset basin further comprises an outer portion of the disk top, a cover, and a supply port, wherein the supply port is adjacent to the outer portion of the disk top and the cover includes an inner thread and the supply port includes an outer thread, wherein the cap is removably attached to the supply port. In another embodiment, the bowl further comprises a meshed junction; and, wherein the meshed junction is placed in the center of the bowl adjacent to the inset basin proximal end; and wherein the meshed junction comprises an opening with a plurality of holes, and the opening creates a connection between the base and the concave inset basin.

In another exemplary embodiment, the attached disk is removable from the concave inset basin to allow access to the feed supply as part of the regular maintenance of the automatic bird feeder. In one embodiment, the basin is detachable from the disk of the concave inset basin, to allow access to the blower unit as part of the regular maintenance of the automatic bird feeder. In another exemplary embodiment both the proximal outer portion of the disk and the basin is detachable to their respective locations in the feeder so that users can access all portions of the wild bird feeder during the routine maintenance of the invention.

In one embodiment, the hollow post further comprises a hollow interior, a supply funnel, and a supply outlet, wherein the supply funnel is located on the lower end and the supply outlet is located on the upper end with the hollow interior connecting both ends. In another embodiment, the nozzle end, the meshed junction, and the supply funnel are vertically aligned. In one embodiment, the feeding area is perpendicular to the base end of the right circular cone; the supply outlet is centered beneath the curved airflow dampener; the feed apertures are directly on top of the perch, wherein the perch is horizontally situated on the hollow post.

Another aspect of the present disclosure is directed to a method for refilling the automatic bird feeder, comprising removing a cover from a supply port; filling bird feed through the supply port on top a concave inset basin; a plugged-in electrical cord being connected to a power supply; said electrical cord powers a blower unit; seeds are transported from the bowl into a hopper unit vertically through a hollow post upon activation of the blower; the blower is deactivated upon filling the hopper unit by removing the electrical cord from the power supply. Another aspect of the present disclosure is directed to a method for refilling the automatic bird feeder, comprising removing a cover from a supply port; filling bird feed through the supply port on top a concave inset basin; a remote attachment is utilized to automatically power on a blower; seeds are transported from a bowl to a hopper unit vertically through a hollow post; a remote attachment is utilized to automatically power off the blower when use is finished.

Other objects, features, and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 exemplarily illustrates a perspective view of an automatic bird feeder, according to an embodiment of the present disclosure;

FIG. 2 exemplarily illustrates a cross sectional view of the automatic bird feeder, according to an embodiment of the present disclosure;

FIG. 3 exemplarily illustrates a cross sectional view of the automatic bird feeder showing the airflow of the automatic bird feeder while in use, according to one embodiment of the present disclosure.

FIG. 4 exemplarily illustrates an enlarged, cross-sectional view of a hopper unit, according to an embodiment of the present disclosure; and

FIG. 5 exemplarily illustrates an enlarged, cross-sectional view of a lower unit, according to one embodiment of the present disclosure.

### DETAILED DESCRIPTION

The present disclosure relates generally to a pneumatic, free standing, hopper bird feeder capable of automatically filling an upper hopper unit with wild bird seed through a blower unit located in its base. The present invention has a weatherproof storage system that keeps the bulk of the bird feed dry no matter the moisture content of the surrounding environment. This innovation improves upon conventional feeders by relocating the feed filling port to the top of the lower unit, rather than at the top of the hopper, which could be upwards of six feet tall. This simplifies the task of refilling the feeder, making it more accessible for users with physical disabilities and increased stability for those experiencing adverse weather conditions. Additionally, the present invention has an enhanced feed storage capacity, capable of accommodating a maximum weight of 50 lbs. This is a notable enhancement in comparison to alternative free-standing feeders. With the combined weight of the feeder components and the added bulk of the bird seed, this style feeder will be more stable against high environmental winds in inclement weather. This stability ensures the bird feeder maintains its structure against threats of weather and thereby allows users to accessibly refill the feeder during adverse weather conditions.

The automatic bird feeder is comprised of a lower unit, a hollow post, and a hopper unit, wherein the lower unit is located at the bottom end of the feeder and the hopper unit is located at the upper end of the feeder and are connected to one another by the hollow post. The lower unit has a hollow, bucket shaped base, and a hollow concave inset basin. The base further comprises multiple air inlets, multiple handles, a cord hole, and a blower affixed to the bottom of the base. There is included in the embodiments a detachable lid and a detachable basin to allow for access to the blower during routine maintenance of the automatic bird feeder.

A description of an embodiment of the present disclosure will now be given with reference to the figures. It is expected that the present disclosure may be embodied in other specific forms without departing from its spirit or essential characteristics. The described embodiment is to be considered in all respects only as illustrative and not restrictive. The scope of the disclosure is, therefore, indicated by the appended claims rather than by the foregoing description. All changes come within the meaning and range of equivalency of the claims are to be embraced within their scope.

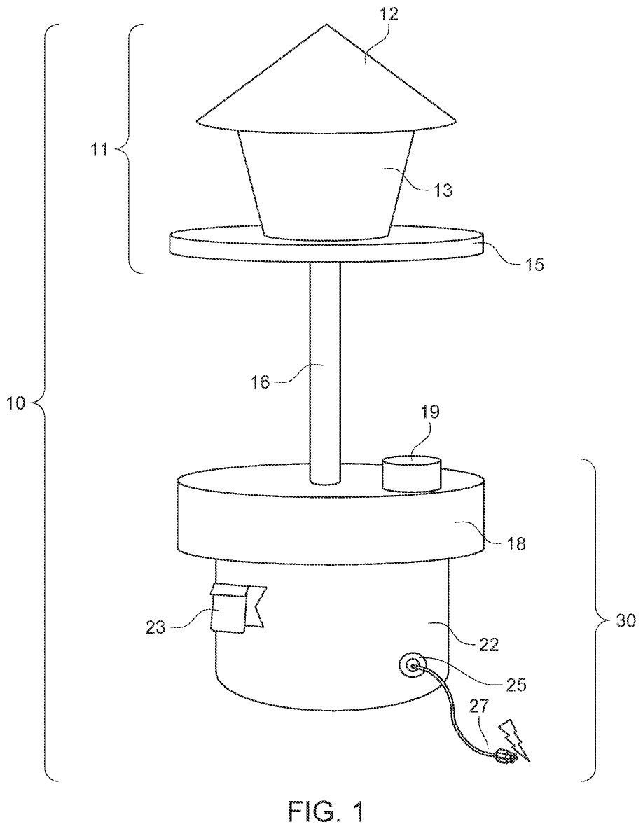

With reference now to the drawings, and in particular to FIGS. 1 through 5 thereof, a new automatic bird feeder embodying the principles and concepts of an embodiment of the disclosure and generally designated by the reference numeral 10 will be described.

In FIG. 1 there is illustrated a perspective view of one embodiment of the automatic bird feeder 10. The automatic bird feeder 10 is comprised of a hopper unit 11 at the upper end of the automatic bird feeder 10 and a lower unit 30 at the lower end, connected to one another through a hollow post 16. The hopper unit 11 further comprising a right circular cone 12, a feeding area 13, and a perch 15. The lower unit 30 further comprising a concave inset basin 18 at the upper end of the lower unit 30 and a base 22 at the lower end of the lower unit 30. On the outside portions of the lower unit 30 there is a handle 23, a cover 19, a cord hole 25 and an electrical cord 27.

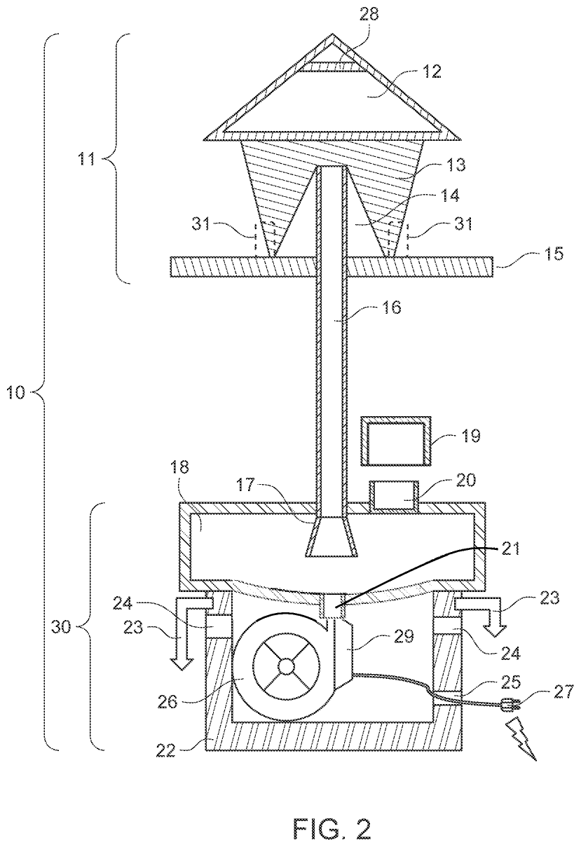

In FIG. 2 there is illustrated a cross-sectional view of an exemplary embodiment of the automatic bird feeder 10. The automatic bird feeder 10 is comprised of the hopper unit 11, hollow post 16, and lower unit 30. The hopper unit 11 and lower unit 30 are connected by the hollow post 16, allowing the connection between the bird seed blown from the lower unit 16 to be received by the hopper unit 11. The hopper unit 11 further comprising a right circular cone 12. having an air dampener 28 within the topmost portion of 12, a feeding area 13 having multiple feed apertures 31 located at the bottom of the feeding area of 13, and a perch 15. The top portion of the hollow post 16 is connected to the hopper unit 11 by a cylindrical supply outlet 14 that keeps feed from congregating in the center of the feeding area 13. The hollow post 16 is connected to the concave inset basin 18 at the upper end of the lower unit 30 and flares outward to create a supply funnel 17 that extends into the concave inset basin 18. The top of the concave inset basin 18 having a cylindrical feed supply port 20 having a removable cover 19 and the bottom of the concave inset basin having a mesh junction 21 flush with the bottom of the concave inset basin 18. The base 22 of the lower unit 30 having multiple handles 23, multiple air inlets 24, and a cord hole 25 on the exterior portion of the base 22. Within the base 22 rests a blower 26 having a remote attachment 29 and an electrical cord 27 extending to the exterior of the base 22 through the cord hole 25.

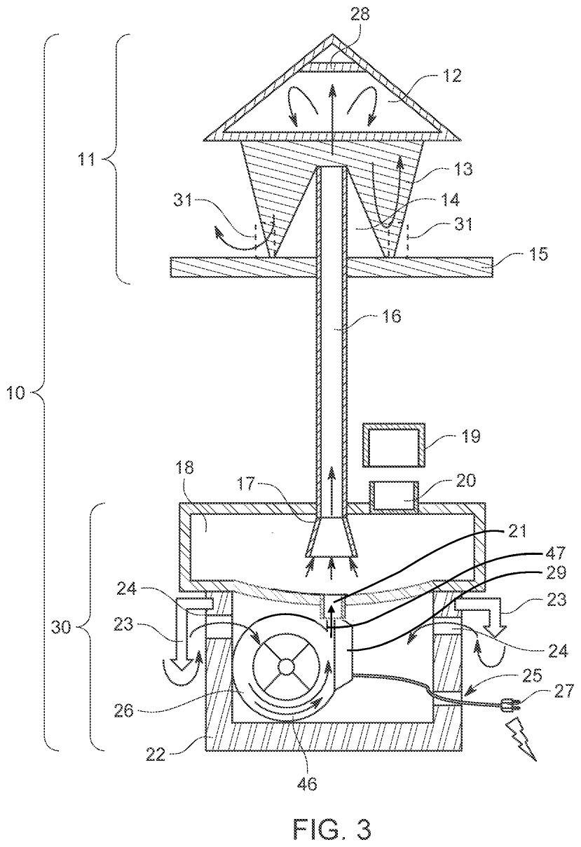

In FIG. 3 there is illustrated the movement of air throughout one embodiment of the automatic bird feeder 10 while the blower 26 is operational. After removing the cover 19 from the supply port 20, seed is inserted into the concave inset basin 18 through the supply port 20. After turning on the blower 26, either mechanically by plugging in the electrical cord 27 into an power system fed through the cord hole 25, or through the remote attachment 29, the seed is delivered from the lower unit 30 to the hopper unit 11. Air is suctioned into the base 22 through the multiple air inlets 24 located below each handle 23 and enters the motor end 46 of the blower 26. The air is then impelled out of the nozzle end 47 of the blower 26, through the meshed junction 21. The meshed junction 21 having a plurality of holes small enough to block bird seed from exiting the concave inset basin 18, while allowing air to flow from the blower 26 to pass through the supply funnel 17 and vertically up through the hollow post 16 where it exits the supply outlet 14 and ricochets off the air flow dampener 28 located in the right circular cone 12 into the bottom of the feeding area 13 and out of the multiple feed apertures 31 to rest on the top of the perch 15.

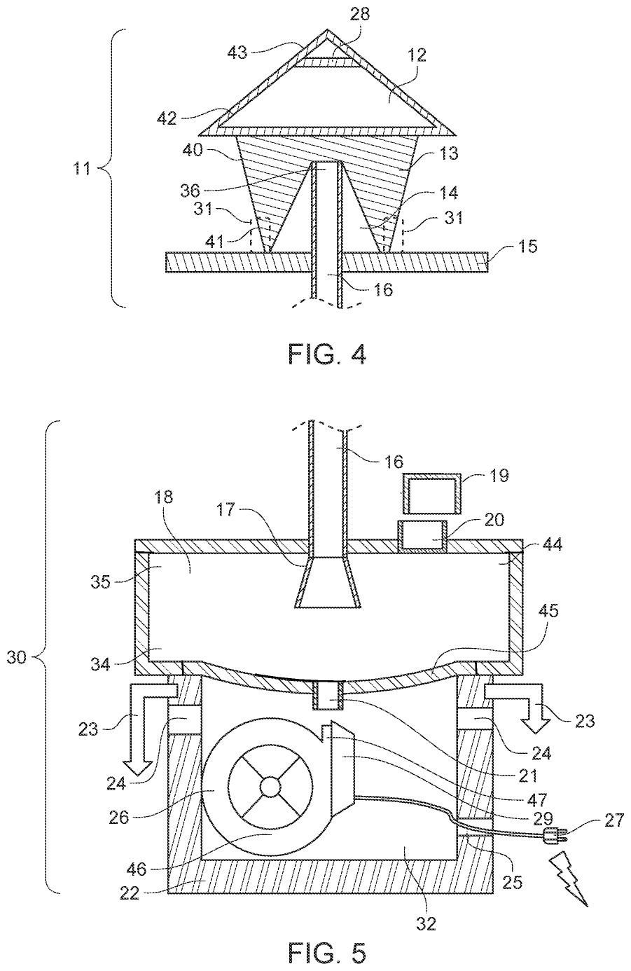

As best illustrated in FIG. 4, the hopper unit 11 is comprised of a right circular cone 12, with a curved airflow dampener 28 attached to the inner, axle end 43 of the right circular cone 12. The curved airflow dampener 28 directs the bird feed towards the feed apertures 31 through which the birds can access the bird feed. At the base end 42 of the right circular cone 12 is the upper end 40 of the feeding area 13 which is configured to have multiple feed apertures 31 at the lower end 41. The upper end 36 of the hollow post 16 extends into the feeding area 13 and is surrounded by the cylindrically shaped supply outlet 14 to prevent seed from settling in the central portion of the feeding area 13. The lower end 41 of the feeding area 13 connects to a perch 15 that extends outward from the external portion of the feeding area 13 and is perpendicular to the hollow tube 16. The outer edge of the perch 15 allows birds to stand as they eat the seed gathered in the lower end 41 of the feeding area 13.

As best illustrated in FIG. 5 an enlarged cross-sectional view of an embodiment of the lower unit 30 comprising a concave inset basin 18, and a base 22.

In one embodiment, the base 22 further comprising multiple handles 23 and multiple inlets 24, a cord hole 25, and a blower 26; wherein the concave inset basin 18 is attached to the base 22. Wherein the multiple handles 23 being configured distally above each of the multiple inlets 24 on the external, vertical walls of the base 22. The multiple handles 23 provide the multiple inlets 24 coverage from the outdoor environment, including preventing leaves from falling into the lower unit 30. Wherein the motor end 46 of the blower 26 is attached to the central, proximal end 32 of the base 22 and the nozzle end 47 of the blower 26 extends vertically from the motor 46. Wherein there is a remote attachment 29 connected to the blower 26. The cord hole 25 accommodates an electrical cord 27 extending from the motor end 46 of the blower 26 to the external portion of the lower unit 30.

In one embodiment the concave inset basin 18 further comprising a disk portion 44 at the distal end 35 of the concave inset basin 18 and a bowl portion 45 at the proximal end 34 of the concave inset basin 18. Wherein the disk portion 44 further comprises a cylindrical supply port 20 with external threads located atop the proximal end 34 of the concave inset basin 18 that is secured by a removable cover 19 having internal threads and connected to lower end of the hollow post 16 and extending into a supply funnel 17. Wherein the bowl portion 45 having in its center a meshed junction 21 to prevent bird seed from entering the nozzle 47 of the blower 26.

The foregoing description comprise illustrative embodiments of the present disclosure. Having thus described exemplary embodiments of the present disclosure, it should be noted by those skilled in the art that within the disclosures are exemplary only, and that various other alternatives, adaptations, and modifications may be made within the scope of the present disclosure. Merely listing or numbering the steps of a method in a certain order does not constitute any limitation on the order of the steps of that method.

Many modifications and other embodiments of the disclosure will come to mind to one skilled in the art to which this disclosure pertains having the benefit of the teachings presented in the foregoing descriptions. Although specific terms may be employed herein, they are used only in a generic and descriptive sense and not for purposes of limitation. Accordingly, the present disclosure is not limited to the specific embodiments of the disclosure, various alternatives, modifications, and equivalents may be used. Therefore, the above description and the examples should not be taken as limiting the scope of the disclosure, which is defined by the appended claims.

The invention claimed is:

1. An automatic bird feeder apparatus comprising:
a lower unit, a hollow post, a hopper unit, a proximal end of the feeder, and a distal end of the feeder, wherein the lower unit on the proximal end of the feeder and the hopper unit on the distal end of the feeder are connected by the hollow post;
wherein the lower unit further comprises a base and a concave inset basin; and
wherein the base further comprises a base proximal end and a base distal end; and
wherein the base further comprises a blower, wherein the blower is fixed to the base proximal end; and
wherein the concave inset basin further comprises a concave inset basin proximal end and a concave inset basin distal end; and
wherein the concave inset basin proximal end is fixed to the base distal end; and
wherein the concave inset basin further comprises a basin and a disk, wherein the disk is fixed on top of the basin; and
wherein the hopper unit is further comprised of a perch, a supply outlet, a feeding area, and a right circular cone; and
wherein the feeding area contains a plurality of feed apertures on external portions of the feed area; and
wherein the supply outlet is fixed within the feeding area and connects the upper end of the hollow post to the upper portion of the perch; and
wherein the right circular cone, being hollow contains a curved airflow dampener fixed on an inner axle end.

2. The automatic bird feeder of claim 1, wherein the blower further comprises:
a nozzle end and a motor end, wherein the motor end is fixed to the base proximal end and the nozzle end is pointed upward vertically; and
a remote attachment, wherein the remote attachment is fixed to the motor end.

3. The automatic bird feeder of claim 1, wherein the blower can be operable manually or by a remote control.

4. The automatic bird feeder of claim 1, wherein the base further comprises a minimum of two attached handles each positioned above one or more air inlets on opposing sides of external walls of the base.

5. The automatic bird feeder of claim 1, wherein the base further comprises a cord hole, an electrical cord, and wherein the cord hole is adjacent to the base proximal end and the electrical cord is connected to the blower and exits through the cord hole to be attached to a power supply.

6. The automatic bird feeder of claim 1, wherein the concave inset basin further comprises an outer portion of the disk top, a cover, and a supply port, wherein the supply port is adjacent to the outer portion of the disk top and the cover includes an inner thread and the supply port includes an outer thread, wherein the cap is removably attached to the supply port.

7. The automatic bird feeder of claim 1, wherein the disk top and the bowl are removable.

8. The automatic bird feeder of claim 1, wherein:
the bowl further comprises a meshed junction, wherein the meshed junction is placed in the center of the bowl and is flush to the inset basin proximal end; and
wherein the meshed junction comprises an opening with a plurality of holes, and the opening creates a connection between the base and the concave inset basin.

9. The automatic bird feeder of claim 1, wherein the hollow post further comprises a hollow interior, a supply funnel, and a supply outlet, wherein the supply funnel is located on the lower end and the supply outlet is located on the upper end with the hollow interior connecting both ends.

10. The automatic bird feeder of claim 1, wherein the nozzle end, the meshed junction, and the supply funnel are vertically aligned.

11. The automatic bird feeder of claim 1, wherein:
the feeding area is perpendicular to the base end of the right circular cone;
the supply outlet is centered beneath the curved airflow dampener;
the feed apertures are directly on top of the perch, wherein the perch is horizontally situated on the hollow post.

12. A method for refilling the automatic bird feeder, comprising:
removing a cover from a supply port;
filling bird feed through the supply port on top a concave inset basin;
a plugged-in electrical cord being connected to a power supply;
said electrical cord powers a blower unit;
seeds are transported from a bowl into a hopper unit vertically through a hollow post upon activation of the blower;
the blower is deactivated upon filling the hopper unit by removing the electrical cord from the power supply.

13. A method for refilling the automatic bird feeder, comprising:
removing a cover from a supply port;
filling bird feed through the supply port on top a concave inset basin;
utilizing a remote control attachment to automatically power on a blower;
seeds are transported from a bowl to a hopper unit vertically through a hollow post;
utilizing the remote control attachment to automatically power off the blower.
